(19) United States
(12) Patent Application Publication
(10) Pub. No.: US 2024/0036726 A1
(43) Pub. Date: Feb. 1, 2024

(54) MEMORY COMPRESSION

(71) Applicant: Rambus Inc., San Jose, CA (US)

(72) Inventors: Evan Lawrence ERICKSON, Chapel Hill, NC (US); Christopher HAYWOOD, Cary, NC (US)

(21) Appl. No.: 18/219,842

(22) Filed: Jul. 10, 2023

Related U.S. Application Data
(60) Provisional application No. 63/392,623, filed on Jul. 27, 2022.

(51) Int. Cl. G06F 3/06

(52) U.S. Cl. CPC G06F 3/0608; G06F 3/0631; G06F 3/064; G06F 3/0673

(57) ABSTRACT

A buffer/interface device of a memory node may read and compress fixed size blocks of data (e.g., pages). The size of each of the resulting compressed blocks of data is dependent on the data patterns in the original blocks of data. Fixed sized blocks of data are divided into fixed size sub-blocks (a.k.a., slots) for storing the resulting compressed blocks of data at with sub-block granularity. Pointers to the start of compressed pages are maintained at the final level of the memory node page tables in order to allow access to compressed pages. Upon receiving an access to a location within a compressed page, only the slots containing the compressed page need to be read and decompressed. The memory node page table entries may also include a content indicator (e.g., flag) that indicates whether any page within the block of memory associated with that page table entry is compressed.

### BRIEF DESCRIPTION OF THE DRAWINGS

FIG. 1 is an illustration of a system that compresses memory contents.

FIGS. 2A-2H are diagrams illustrating memory compression.

FIGS. 3A-3I are diagrams illustrating example memory compression and decompression operations.

FIGS. 4A-4B are diagrams illustrating page table walks with decreased latency.

FIG. 5 is a flowchart illustrating a method of compressing memory.

FIG. 6 is a flowchart illustrating a method of compressing and decompressing memory.

FIG. 7 is a flowchart illustrating a method of maintaining a page table.

FIG. 8 is a flowchart illustrating a method of walking a page table.

FIG. 9 is a flowchart illustrating a method of decreasing page table walk latency.

FIG. 10 is a flowchart illustrating a method of selecting a page of memory for compression.

FIG. 11 is a flowchart illustrating a latency based method of selecting a page of memory for compression.

FIG. 12 is a flowchart illustrating a latency based method of selecting a page of memory for allocation.

FIG. 13 is a flowchart illustrating a latency and access frequency based method of selecting a page of memory for compression.

FIG. 14 is a block diagram of a processing system.

### DETAILED DESCRIPTION OF THE EMBODIMENTS

In an embodiment, a memory node receives host physical addresses for accesses. In other words, addresses that are tied to the host's perception of physical memory and associated memory map. A memory node, however, may not conform to the host's perception and/or memory map. This can allow the memory node to more efficiently manage physical memory resources by, for example, rearranging, compressing, and/or decompressing pages.

A memory node may maintain a map that relates host physical addresses to the device physical addresses used to address the memory devices on the memory node. This map may be referred to as a memory node page table. A memory node page table may have multiple levels and function similar to the virtual address to physical address translation page tables used by central processing units (CPUs). The memory node page table entries may also contain additional information about associated pages and/or groups of pages. A memory node page table's mappings of host physical addresses to memory node device addresses may be private to the memory node and may function entirely without the host's knowledge of the contents of the memory node page table. Thus, it should be understood that references made herein to “page table” and “page table entry” are referring to the mappings and associated data structures generated and maintained by the memory node and not to the virtual to physical address translation page tables maintained and used by the host.

A buffer/interface device of the memory node may read and compress blocks of data (e.g., pages). The size of each of the resulting compressed blocks of data is dependent on the data patterns in the original blocks of data. In an embodiment, fixed sized blocks of data are divided into fixed size sub-blocks (a.k.a., slots) for storing the resulting compressed blocks of data. For example, a 4 kilobyte page (a.k.a., block) of data may be divided into four 1 kilobyte “slots” that are used to store compressed pages. Each compressed page is stored in either one, two, or three slots. Pages that compress to sizes greater than three slots are left uncompressed. Other slot sizes are contemplated. For example, eight 512-byte slots per 4 kilobyte page may be used to store compressed pages.

Pointers to the start of compressed pages are maintained at the final level of the memory node page tables in order to allow access to compressed pages. In other words, the final level page table entry for a compressed page include a pointer to the “slot” where the compressed page starts. The final level of the page tables may also include information on the size (e.g., number of slots) of the compressed page. Upon receiving an access to a location within a compressed page, only the slots containing the compressed page need to be read and decompressed.

The memory node page table entries may also include a content indicator (e.g., flag) that indicates whether any page within the block of memory associated with that page table entry is compressed. Thus, if the content indicator for a page table entry (e.g., top level page table entry) indicated that no pages in the range of memory associated with that entry are compressed, the walking of the lower levels of the page table are not necessary and the least significant bits (LSB) of the host physical address may be used to complete the full memory node device address. Not walking the lower levels of the page table reduces the latency required to obtain the full memory node device address.

In addition, the content indicators may be used in the selection of pages to be compressed. For example, if a first block of memory associated with a first page table entry is indicated to include a compressed page, while a second block of memory associated with a second page table entry is indicated to not include a compressed page, selecting a page from the first block of memory to compress will not increase the time needed to fully walk the page table. Whereas selecting a page from the second block of memory will, after that page is compressed, require a full page table walk that was not required before that page was compressed.

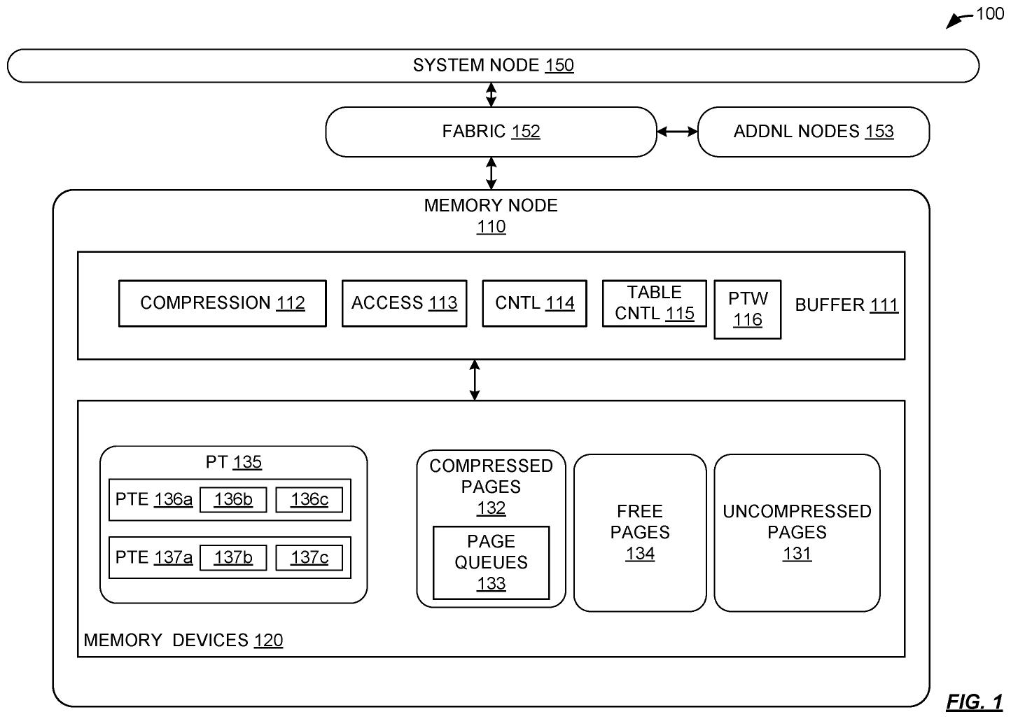

FIG. 1 is an illustration of a system that compresses memory contents. In FIG. 1, system 100 comprises system node 150, fabric 152, additional nodes 153, and memory node 110. Memory node 110 includes buffer device 111, and memory devices 120. The contents residing in memory devices 120 includes uncompressed pages 131, compressed pages 132, free pages 134, and page table 135. Compressed pages 132 may include page queues 133. Page table 135 may include page table entries 136a-137a. Page table entries 136a-137a may include content indicators 136b-137b (e.g., flags), respectively. Page table entries 136a-137a may include access frequency indicators 136b-137b (e.g., access counts), respectively. Page table entry 136a may be associated with a one of the compressed pages 132. Page table entry 137a may be associated with a one of uncompressed pages 131.

System node 150, memory node 110, and additional nodes 153 are operatively coupled to fabric 152. System node 150, memory node 110, and additional nodes 153 are operatively coupled to fabric 152 to communicate and/or exchange information etc. with each other. Fabric 152 may be or comprise a switched fabric, point-to-point connections, and/or other interconnect architectures (e.g., ring topologies, crossbars, etc.). Fabric 152 may include links, linking, and/or protocols that are configured to be cache coherent. For example, fabric 152 may use links, linking, and/or protocols that include functionality described by and/or are compatible with one or more of Compute Express Link (CXL), Coherent Accelerator Processor Interface (CAPI), and Gen-Z standards, or the like. In an embodiment, system node 150, memory node 110, and additional nodes 153 are operatively coupled to fabric 152 to request and/or store information from/to that resides within other of system node 150, memory node 110, and/or additional nodes 153. In an embodiment, additional nodes 153 may include similar or the same elements as system node 150, and/or memory node 110 and are therefore, for the sake of brevity, not discussed further herein with reference to FIG. 1.

In an embodiment, buffer device 111 includes compression/decompression circuitry 112 (hereinafter, just “compression circuitry 112”), access circuitry 113, control circuitry 114, page table control circuitry 115, and page table walker circuitry 116. Page table walker circuitry 116 is operatively coupled to page table control circuitry 115, access circuitry 113, control circuitry 114, and page table control circuitry 115. Access circuitry 113 is operatively coupled to memory devices 120. Access circuitry 113 is configured to access at least one of memory devices 120 to access uncompressed pages 131, compressed pages 132, free pages 134, and page table 135 stored by memory devices 120.

Memory node 110 (and buffer device 111, in particular) is operatively coupled to fabric 152 to receive, from system node 150, access requests (e.g., reads and writes). Access requests transmitted by system node 150 may include read requests (e.g., to read a cache line sized block of data) and write requests (e.g., to write a cache line sized block of data). In an embodiment, to respond to the read or write request, buffer device 111 (and page table walker circuitry 116, in particular) may perform a page table walk to relate the addressed received from system node 150 to a physical address that is used by memory devices 120 (e.g., to address a cache line in one of compressed pages 132 or uncompressed pages 131).

Buffer device 111 of memory node 110 may select one or more uncompressed pages 131 to be compressed. Access circuitry 113 may then read the selected uncompressed page(s) from memory devices 120 and provide the uncompressed pages to compression circuitry 112. The size of each of the resulting compressed pages of data is dependent on the data patterns in the original uncompressed pages 131. In an embodiment, buffer device 111 (and control circuitry 114, in particular) divides pages that are storing, or are to store, the compressed pages 132 into fixed size sub-pages (a.k.a., slots). An integer number of slots is used to store the compressed page data with any remaining space in the last slot going unused. In this manner, each compressed page will begin on a slot boundary. Beginning each compressed page on a slot boundary shortens the memory device physical address to be stored in page table 135. Furthermore, having a small number of slots (e.g., 4 or 8) reduces the overhead for efficiently packing multiple compressed pages into the space of an uncompressed data page when compared to selecting compressed page starting locations from a range of byte addresses.

In an example, 4 kilobyte pages of data may be divided into four 1 kilobyte slots that are used to store compressed pages. Each compressed page is stored in either one, two, or three slots. Pages that compress to sizes greater than three slots are left uncompressed. It should be understood that other slot sizes are contemplated. For example, eight 512-byte slots per 4 kilobyte page may be used to store compressed pages.

Page table control circuitry 115 maintains page table 135 to allow the translation of addresses received from system node 150 to addresses usable by memory devices 120. In particular, page table control circuitry 115 maintains pointers to the start of uncompressed and compressed pages. These pointers may be maintained at the final level of page table 135 in order to allow access to both uncompressed pages 131 and compressed pages 132.

Page table control circuitry 115 may also maintain a content indicator 136b-137b (e.g., flag) at the final level of page table 135 to indicate whether the page pointed to by the page table entry 136a-137a is uncompressed or compressed. In the case of the page table entry 136a-137a pointing to an uncompressed page, the least significant bits (e.g., 2 LSB for four slots, or 3 LSB for eight slots) of the pointer value are either set to, or assumed be a fixed value (e.g., zero). In the case of the page table entry 136a-137a pointing to a compressed page, the least significant bits (e.g., 2 LSB for four slots, or 3 LSB for eight slots) of the pointer value indicate the starting slot of the compressed page.

Page table control circuitry 115 may also, for compressed pages, maintain information on the size (e.g., number of slots) of the compressed page associated with the corresponding page table entries 136a-137a. Thus, upon receiving an access to a location within one of compressed pages 132, buffer device 111 need only read (by access circuitry 113) and decompress (by compression circuitry 112) those slots that are storing the compressed page that is being accessed.

Page table control circuitry 115 may also maintain page table entries 136a-137a that include content indicators 136b-137b (e.g., flags) that indicate whether any page within the block of memory associated with that page table entry 136a-137a is compressed. Content indicators 136b-137b may be maintained at more than just the last level of page table 135 (e.g., all levels). When page table walker circuitry 116 walks page table 135, if the content indicator 136b-137b for a page table entry 136a-137a (e.g., top level or a middle level) indicates that no pages in the range of memory associated with that page table entry 136a-137a are compressed, page table walker circuitry 116 may stop the page table walk and use the least significant bits of the host physical address to complete the full memory node device address.

XX

Page table control circuitry 115 may also maintain page table entries 136a-137a that include access frequency indicators 136b-137b (e.g., counts) that indicate how frequently (or infrequently) a given page (or range of pages) has been accessed. Access frequency indicators 136c-137c may be maintained at more than just the last level of page table 135 (e.g., all levels).

In addition, content indicators 136b-137b may be used in the selection of pages to be compressed (e.g., by control circuitry 114). For example, if a first block of memory associated with a first page table entry (e.g., page table entry 136a) is indicated (e.g., by content indicator 136b) to include a compressed page, while a second block of memory associated with a second page table entry (e.g., page table entry 137a) is indicated (e.g., by content indicator 137b) to not include a compressed page, selecting a page from the first block of memory to compress will not increase the time needed to fully walk the page table. Whereas, selecting a page from the second block of memory will, after that page is compressed, require a full page table walk that was not required before that page was compressed.

Access frequency indicator 136c-137c and content indicators 136b-137b may be used in combination (or alone) in the selection of pages to be compressed (e.g., by control circuitry 114). For example, if a first block of memory associated with a first page table entry (e.g., page table entry 136a) is indicated (e.g., by content indicator 136b) to include a compressed page, while a second block of memory associated with a second page table entry (e.g., page table entry 137a) is indicated (e.g., by content indicator 137b) to not include a compressed page, but the access frequency indicators associated with the first page and the second page indicate the first page is infrequently accessed when compared to the second page, selecting a page from the second block of memory to compress may not increase the average access time even when having to fully walk the page table. Whereas, selecting a page from the first block of memory will, after that page is compressed, require a full page table walk but will only occur infrequently thereby not increasing the average access time.

In an embodiment, four kilobyte (4 KiB or 4096 bytes) pages comprise sixty-four (64) cache lines that are each sixty-four (64) bytes in size. To compress a 4 KiB pages, the 64 cache lines of a page accessed (e.g., by access circuitry 113) and provided to compression circuitry 112. As discussed herein, the size of each of the resulting compressed pages 132 are dependent on the data pattern corresponding ones of the uncompressed pages 131. Due to the overhead (e.g., time, power, blocked resources, etc.) pages that compress to greater than 3 KiB should be compressed. In an embodiment, to reduce the access latency of compressed pages 132, the minimum compression ratio of compressed pages 132 that are stored as compressed pages 132 (rather than being left as uncompressed pages 131) may be greater than or equal to 2:1 (uncompressed size to compressed size).

In an embodiment, the pages holding compressed page data are divided into fixed size regions. In an embodiment, these regions are of uniform size. For example, a 4 KiB page designated to hold multiple compressed pages 132 may be divided into four (4) 1 KiB slots. The compressed pages thus fit into 1, 2, or 3 slots. It should be understood that smaller or larger slots may be implemented. For example, a 4 KiB page may be divided into eight (8) 512 byte slots. In other embodiments, these regions or slots may be non-uniform is size.

Pointers to the start of a compressed page (along with an indicator that the page is compressed) may be stored in the final (or last) level of the memory node page table 135. Upon receiving an access to a cache line that is within the address range of a compressed page, accesses may be reduced by only accessing the compressed data in the slots that contain the compressed page. Likewise, overhead is reduced by providing only the compressed data in the slots that contain the compressed page to compression circuitry 112 for decompression into a uncompressed page 131.

In an embodiment, memory node 110 has, for example, 2 terabytes (2 TiB) of physical memory. Thus, memory devices 120 may addressed by 41-bit address values. This allows for final page table entries (e.g., page table entries 136a-137a) to have entries in the 4-8 byte range. For example, a final page table entries 136a-137a may store a 31-bit physical address pointing to a 1 KiB slot, 1-bit flag (a.k.a., compressed flag) indicating whether the page is compressed (or not), and additional flags.

For uncompressed pages 131, the compressed flag is set to indicate the page is uncompressed (e.g., ‘0’) and the 31-bit physical address points to one of uncompressed pages 131. The least significant 2-bits of the 31-bit physical address may either be set to a known value (e.g., ‘00’) or be interpreted as being a known value (e.g., ‘00’) regardless of the actual value of the least significant 2-bits (e.g., ‘11”).

For uncompressed pages, the compressed flag is set to indicate the page is uncompressed (e.g., ‘0’) and the 31-bit physical address points to the start (e.g., starting slot) of the compressed page 132. In an embodiment, the size of the compressed page (e.g., 1, 2, or 3) is stored in an additional 2-bits of the page table entry (e.g., page table entries 136a-137a). In another embodiment, the size of the compressed page (e.g., 1, 2, or 3) is stored in metadata at a known location. For example, the metadata indicating the size (i.e., number of slots or bytes) of the compressed page of data may be placed before the compressed data in the first slot. Other locations for the metadata are contemplated.

In an embodiment, 4 KiB pages are divided into four 1 KiB slots. To pack compressed pages into these four slots, control circuitry 114 may maintain four queues (a.k.a., compression queues) holding pointers to pages that have “free” slots that are available to receive compressed data. Three of these queues hold pointers to pages with 1, 2, or 3 free slots, respectively. The fourth queue holds pointers to pages that are fully free (i.e., have four free slots). In another example, 4 KiB pages that are divided into eight 512 byte slots would use eight queues with 1-7 free slots, respectively.

Uncompressed pages 131 are read from memory devices 120 and provided to compression circuitry 112. The compressed data may fit into 1, 2, or 3 slots. If the compressed data requires four (4) slots, the compression of the page may be halted without writing the data to memory devices 120. Based on the number of slots needed to hold the compressed data, a queue is selected. In other words, if the compressed data needs only one slot, then the 1-slot available page queue is selected. If the compressed data needs two slots, then the 2-slot available page queue is selected, and so. For the selected queue, a physical page address is selected to hold the compressed data. For example, the physical page pointed to by the “top” of the queue may be “popped” from the queue and the compressed data written to the available slots. The page table entry corresponding to compressed page is updated with the selected physical page address so that accesses to the address range associated with the compressed page will resolve (via the page table walk) to the corresponding slot(s) in the selected page.

In an embodiment, the queues may be managed if one or more of the queues exceed one or more size thresholds. For example, if the queues exceed a first size threshold, compressed pages 132 each with two free slots (and thus, two full slots each) may be combined to make one page with no free slots and one page with all free slots. In another example, if the queues exceed a second size threshold, pages that, once compressed, need to occupy three slots may no longer be written to memory devices 120 (at least until the second threshold is no longer met). This example illustrates dynamically varying the maximum compression ratio required for a page to be compressed.

In an embodiment, multiple sets of compression queues may be used to isolate user data at the hypervisor or virtual machine software level. Isolation via these multiple sets of compression queues may be used to recover memory freed by the compression process for re-use by other processes, the hypervisor, or virtual machine.

In an embodiment, the fully free page queue may be empty initially. As pages are compressed and packed together in memory devices 120, the fully free page queue may become populated with fully free pages that used to hold uncompressed data. These newly free pages may be zeroed or otherwise overwritten to obscure their former contents. As the fully free page queue reaches a threshold number of pages (i.e., size), pages may be removed from the queue for re-use by processes, and/or system tasks (e.g., hypervisor, virtual machines, etc.) For example, free pages may be combined into an allocation block.

In another example, if a system node 150 is managing free page recovery, the fully free page queue may be used to indicate pages that are available for re-use/recovery. In an embodiment a kernel process running on system node 150 may reclaim pages from the fully free page queue for re-use by processes, and/or system tasks. Excess pages in the fully free page queue may be reclaimed while new pages are added as necessary through, for example, one or more of swapping to disk or compression. Adding pages helps ensure that there are always enough fully free pages to support the decompression of compressed pages 132. In addition, the compression queues may be accessible to system node 150 to allow system node 150 to monitor the usage of the compression queues directly (e.g., with load/stores and/or an application programming interface-API).

In another example, a virtual machine (VM) and/or Hypervisor running on system node 150 monitors the fully free page queue or receives addresses of free pages from memory node 110 when the number of entries in the free page queue exceeds a threshold number of pages (i.e., size). In this example, the benefit from compression of the freed pages is realized by system node 150 as it re-allocates freed pages for another use after compression by the memory node 110. System node 150 may could re-allocate these freed pages through, for example, an API call, as a response to another command (like a compression request), or via monitoring the free page queue explicitly such that the host (VM/hypervisor) learns of pages it can re-use for other purposes and thus gain a benefit from compression.

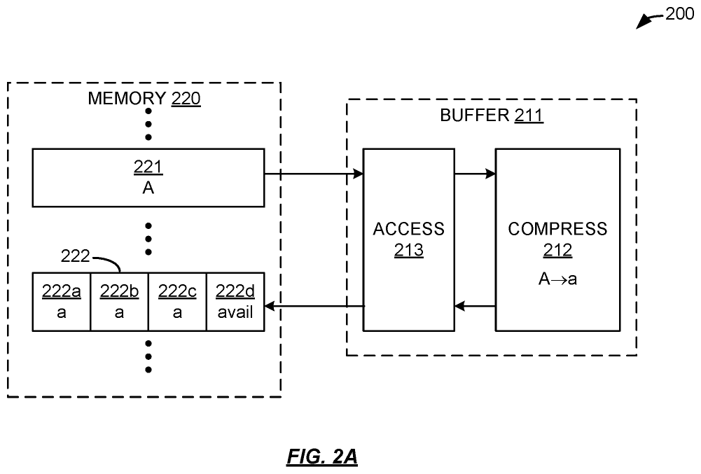

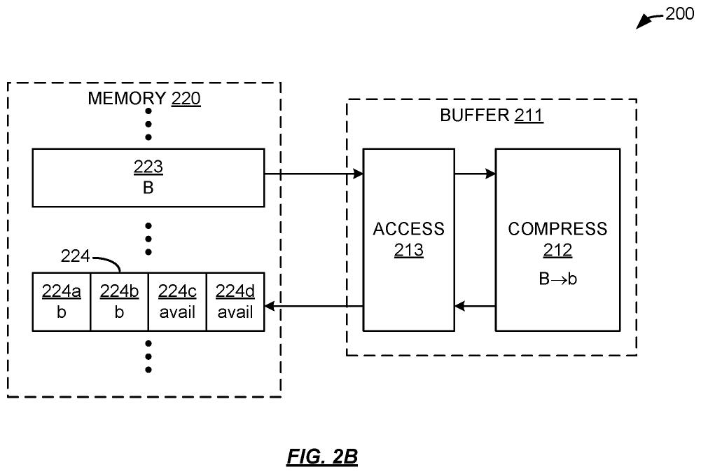

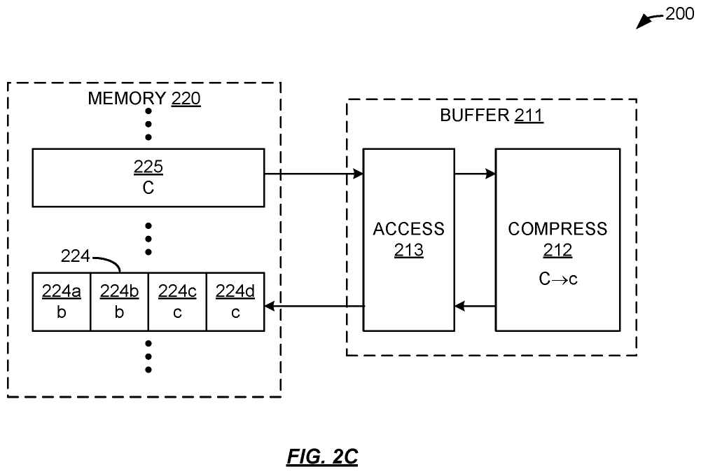

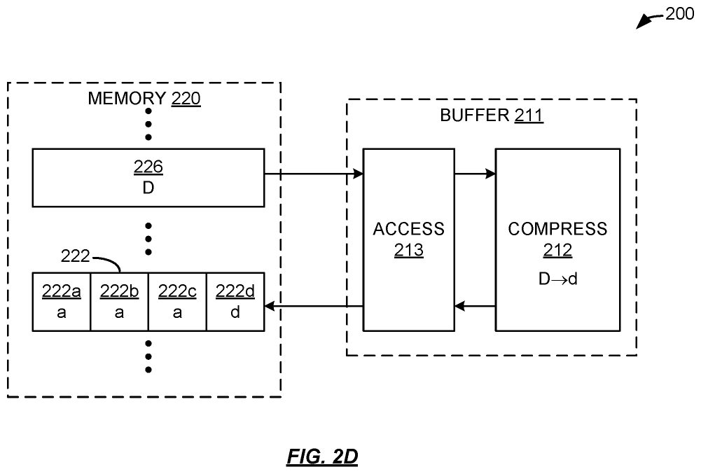

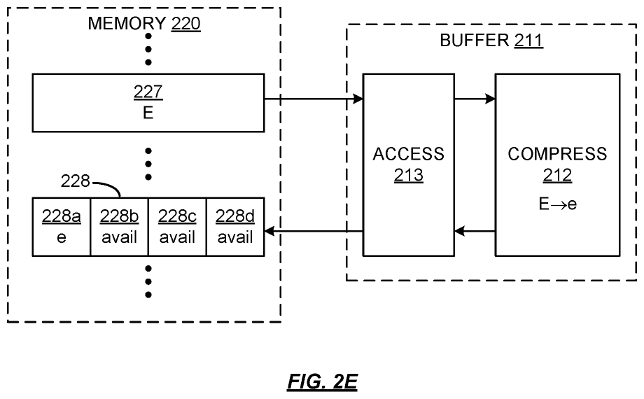

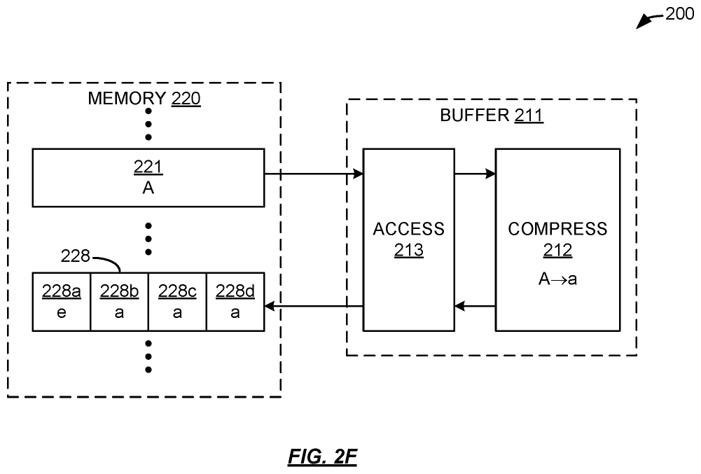

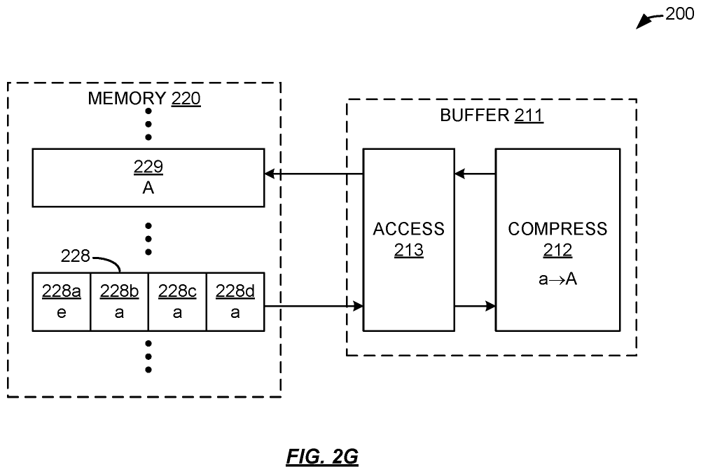

FIGS. 2A-2H are diagrams illustrating memory compression. In FIG. 2A-2H, system 200 comprises buffer device 211 and memory devices 220. System 200 may comprise, for example, a portion of system 100 and/or memory node 110. Buffer device 211 includes access circuitry 213 and compression circuitry 212. Note that in FIGS. 2A-2H, memory devices 220 may not, in some embodiments, concurrently store both an uncompressed page and its compressed version.

In a first example, as illustrated in FIG. 2A, access circuitry 213 reads uncompressed page 221 and provides the uncompressed contents, “A”, of uncompressed page 221 to compression circuitry 212. Compression circuitry 212 compresses the contents “A” of uncompressed page 221 to compressed data “a” that will need to occupy three slots. Compressed data “a” is provided to access circuitry 213. Access circuitry 213 writes compressed data “a” to three slots 222a-222c of compressed page 222. Slot 222d of compressed page 222 is available to hold other compressed data.

In a second example, as illustrated in FIG. 2B, access circuitry 213 reads uncompressed page 223 and provides the uncompressed contents, “B”, of uncompressed page 223 to compression circuitry 212. Compression circuitry 212 compresses the contents “B” of uncompressed page 223 to compressed data “b” that will need to occupy two slots. Compressed data “b” is provided to access circuitry 213. Access circuitry 213 writes compressed data “b” to two slots 224a-224b of compressed page 224. Slots 224c-224d of compressed page 224 is available to hold other compressed data.

A third example starts from the end of the second example. In the third example, as illustrated in FIG. 2C, access circuitry 213 reads uncompressed page 225 and provides the uncompressed contents, “C”, of uncompressed page 225 to compression circuitry 212. Compression circuitry 212 compresses the contents “C” of uncompressed page 225 to compressed data “c” that will need to occupy two slots. Compressed data “c” is provided to access circuitry 213. Access circuitry 213 writes compressed data “c” to two available slots 224c-224d of compressed page 224. After compressed data “c” is written to slots 224c-224d, no slots of compressed page 224 remain available to hold other compressed data.

A fourth example starts from the end of the first example. In the fourth example, as illustrated in FIG. 2D, access circuitry 213 reads uncompressed page 226 and provides the uncompressed contents, “D”, of uncompressed page 226 to compression circuitry 212. Compression circuitry 212 compresses the contents “D” of uncompressed page 225 to compressed data “d” that will need to occupy one slot. Compressed data “d” is provided to access circuitry 213. Access circuitry 213 writes compressed data “d” to one available slot 224c-222d of compressed page 222. After compressed data “d” is written to slot 222d, no slots of compressed page 222 remain available to hold other compressed data.

In a fifth example, as illustrated in FIG. 2E, access circuitry 213 reads uncompressed page 227 and provides the uncompressed contents, “E”, of uncompressed page 227 to compression circuitry 212. Compression circuitry 212 compresses the contents “E” of uncompressed page 227 to compressed data “e” that will need to occupy one slot. Compressed data “e” is provided to access circuitry 213. Access circuitry 213 writes compressed data “e” to one slot 228e of compressed page 228. Slots 228b-228d of compressed page 222 remain available to hold other compressed data.

A sixth example starts from the end of the fifth example. In the fifth example, as illustrated in FIG. 2F, access circuitry 213 reads uncompressed page 221 and provides the uncompressed contents, “A”, of uncompressed page 221 to compression circuitry 212. Compression circuitry 212 compresses the contents “A” of uncompressed page 221 to compressed data “a” that will need to occupy three slots. Compressed data “a” is provided to access circuitry 213. Access circuitry 213 writes compressed data “a” to three slots 228b-228d of compressed page 228. After compressed data “d” is written to slots 228b-228d, no slots of compressed page 228 remain available to hold other compressed data.

A seventh example starts from the end of the sixth example. In the seventh example, as illustrated in FIG. 2G, access circuitry 213 reads slots 228b-228d of compressed page 228 and provides the compressed contents, “a”, of slots 228b-228d to compression circuitry 212. Compression circuitry 212 decompresses the contents “a” of slots 228b-228d to uncompressed page data “A” that will need to occupy an entire page. Uncompressed page data “A” is provided to access circuitry 213. Access circuitry 213 writes uncompressed page data “A” to uncompressed page 229. As illustrated in FIG. 2H, after uncompressed data “a” is read from slots 228b-228d, slots 228b-228d of compressed page 228 become available to hold other compressed data.

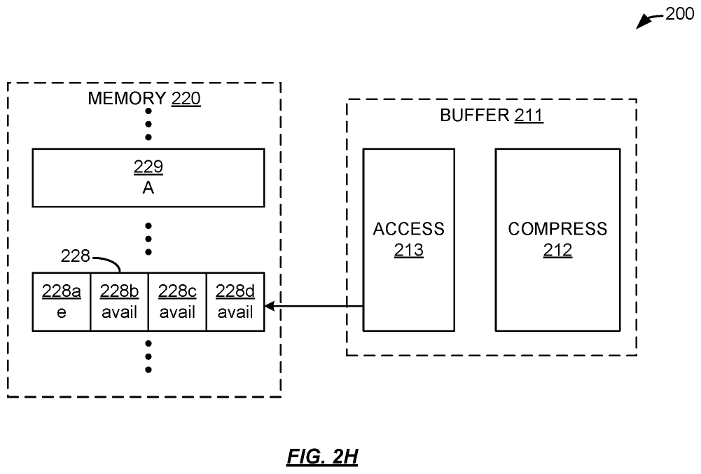

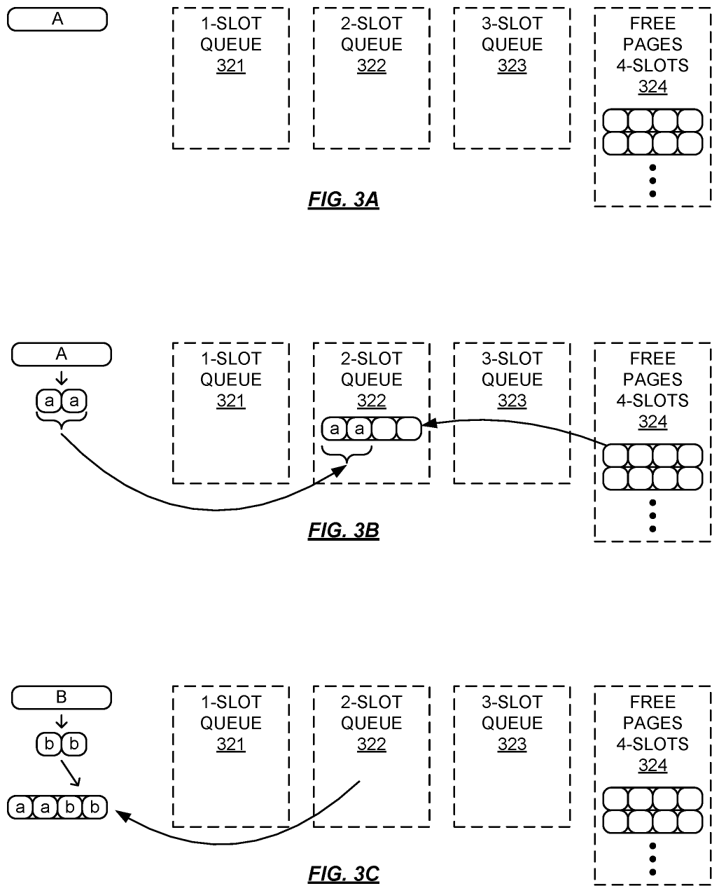

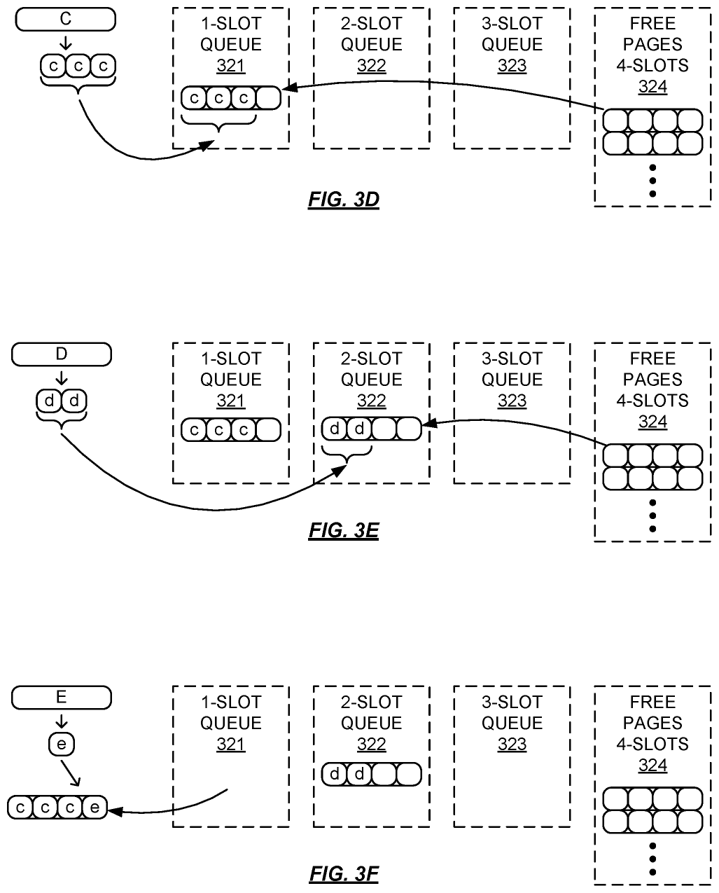

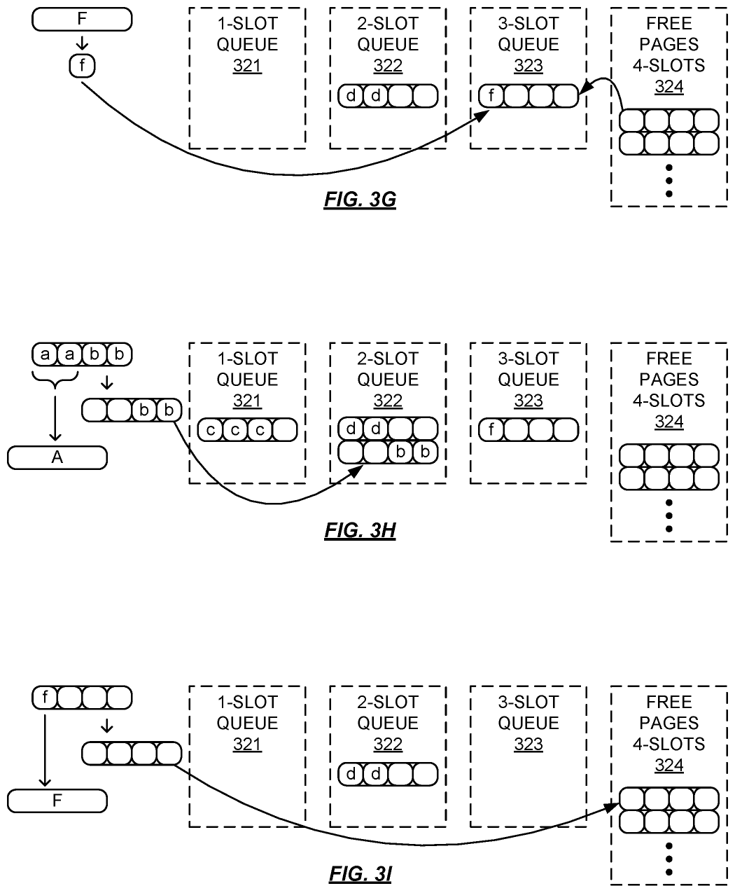

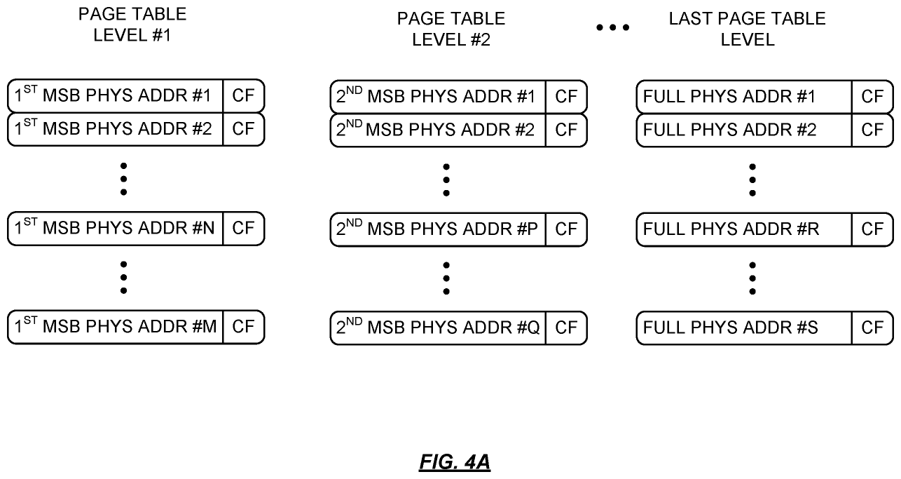

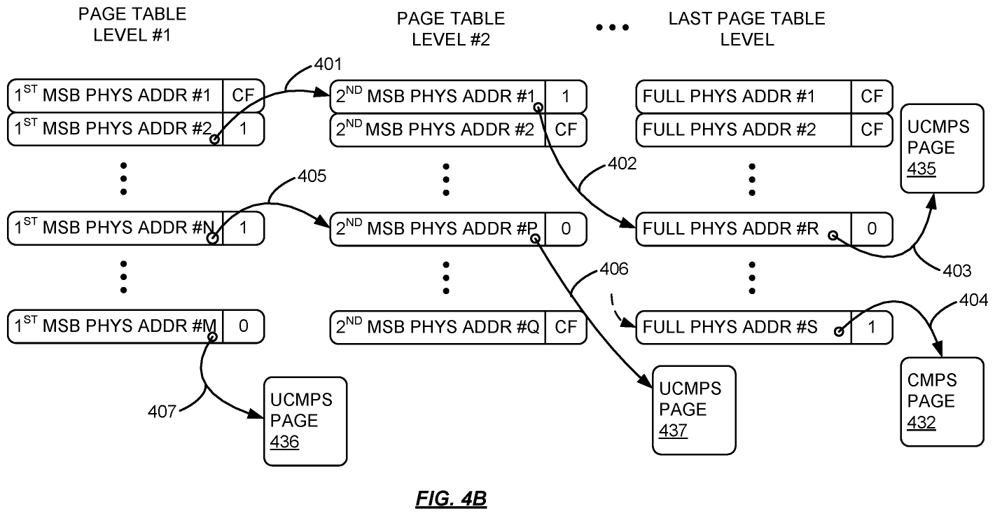

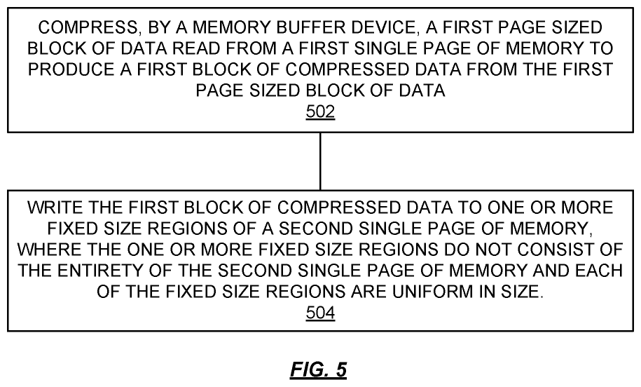

FIGS. 3A-3I are diagrams illustrating example memory compression and decompression operations. One or more of the operations illustrated in FIGS. 3A-3I may be performed by, for example, system 100, system 200, and/or their components. FIGS. 3A-3I illustrate example operations involving a queue pointing to pages with one slot available (a.k.a., 1-slot queue 321), a queue pointing to pages with two slots available (a.k.a., 2-slot queue 322), a queue pointing to pages with three slots available (a.k.a., 3-slot queue 323), and a queue pointing to free pages that therefore have four slots available (a.k.a., free pages queue 324).

FIG. 3A illustrates an example initial condition. In FIG. 2A, 1-slot queue 321, 2-slot queue 322, and 3-slot queue 323 are empty. Free pages queue 324 contains pointers to a plurality of fully available pages. Uncompressed page A is also illustrated in FIG. 2A.

In FIG. 3B, uncompressed page A is compressed to compressed data “a” that is to occupy two slots. A fully available page is selected from the free pages queue 324, compressed data “a” is written to the selected page, and the selected page holding compressed data “a” is moved to the 2-slot queue 322. This is illustrated in FIG. 3B by the arrow running from a page in free pages queue 324 to 2-slot queue 322, and the arrow from the two slots of “a” to two slots in the selected page in 2-slot queue 322.

In FIG. 3C, uncompressed page B is compressed to compressed data “b” that is to occupy two slots. A page is selected from the 2-slot queue 322, compressed data “b” is written to the selected page, and the selected page holding four slots of compressed data (e.g., “a” and “b”) is removed from the 2-slot queue 322. This is illustrated in FIG. 3C by the arrow running from a page in 2-slot queue 322 to a page holding compressed data “a” and compressed data “b” that is not in any of the queues 321-324.

In FIG. 3D, uncompressed page C is compressed to compressed data “c” that is to occupy three slots. A fully available page is selected from the free pages queue 324, compressed data “c” is written to the selected page, and the selected page holding compressed data “c” is moved to the 1-slot queue 321. This is illustrated in FIG. 3D by the arrow running from a page in free pages queue 324 to 1-slot queue 321, and the arrow from the three slots of “c” to three slots in the selected page in 1-slot queue 321.

In FIG. 3E, uncompressed page D is compressed to compressed data “d” that is to occupy two slots. A fully available page is selected from the free pages queue 324, compressed data “d” is written to the selected page, and the selected page holding compressed data “d” is moved to the 2-slot queue 322. This is illustrated in FIG. 3E by the arrow running from a page in free pages queue 324 to 2-slot queue 322, and the arrow from the two slots of “d” to two slots in the selected page in 2-slot queue 322.

In FIG. 3F, uncompressed page E is compressed to compressed data “e” that is to occupy three slots. A page is selected from the 1-slot queue 321, compressed data “e” is written to the selected page, and the selected page holding four slots of compressed data (e.g., “c” and “e”) is removed from the 1-slot queue 321. This is illustrated in FIG. 3F by the arrow running from a page in 1-slot queue 321 to a page holding compressed data “c” and compressed data “e” that is not in any of the queues 321-324.

In FIG. 3G, uncompressed page F is compressed to compressed data “f” that is to occupy one slot. A fully available page is selected from the free pages queue 324, compressed data “f” is written to the selected page, and the selected page holding compressed data “f” is moved to the 3-slot queue 323. This is illustrated in FIG. 3G by the arrow running from a page in free pages queue 324 to 3-slot queue 323, and the arrow from the one slot of “e” to one slot in the selected page in 3-slot queue 323.

In FIG. 3H, compressed page “a” is decompressed to uncompressed page A. The decompression of “a” from a page that held two slots of compressed data “a” and two slots of compressed data “b”, results in a page with two available slots. The page with two available spots, and the compressed data “b” is placed in 2-slot queue 322. This is illustrated in FIG. 3H by the arrows running from a page that held two slots of compressed data “a” and two slots of compressed data “b” to a page holding uncompressed page A and a compressed page in 2-slot queue 322 that is holding two slots of compressed data “b”.

In FIG. 3I, compressed page “f” is decompressed to uncompressed page F. The decompression of “f” from a page that held one slot of compressed data “f” and three available slots, results in a free page with four available slots. The page with four available spots is placed in free pages queue 324. This is illustrated in FIG. 3I by the arrows running from a page that held one slot of compressed data “f” and three available slots to a page holding no compressed data in the free pages queue 324.

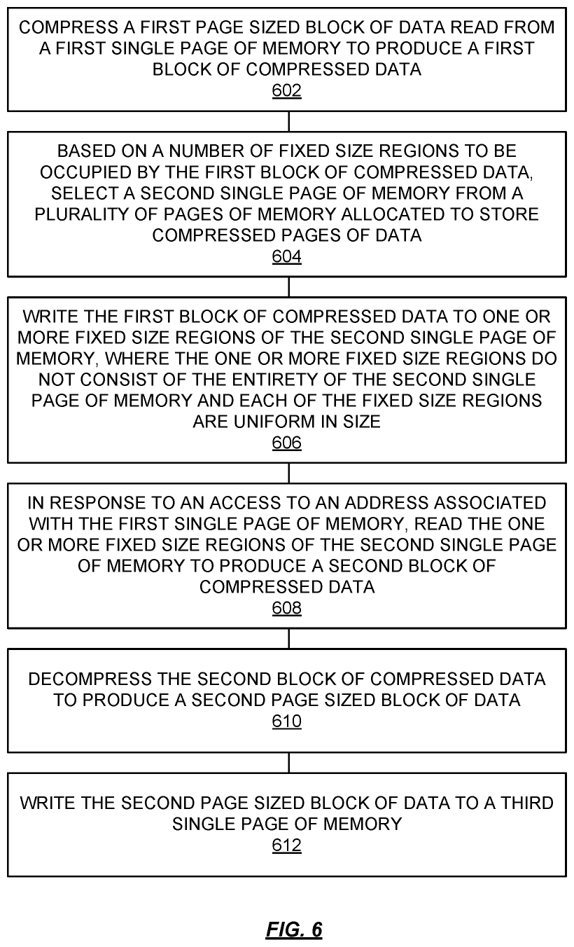

FIGS. 4A-4B are diagrams illustrating page table walks with decreased latency. One or more of the operations and/or page tables illustrated in FIGS. 4A-4B may be used by, or performed by, for example, system 100, system 200, and/or their components. In FIGS. 4A-4B, a plurality of levels of page table are illustrated. The page table entries in the first page table level (“page table level #1”) include a pointer to a first number of most significant bits (MSB) of a physical address and a content flag (a.k.a., content indicator). In embodiment, the first number of most significant bits (MSB) of the physical addresses are 14-bits of the device physical address (e.g., the addresses used to address memory devices 120). The page table entries in the second page table level (“page table level #2”) include a pointer to a second number of most significant bits (MSB) of a physical address and a content flag (a.k.a., content indicator). In embodiment, the second number of most significant bits (MSB) of the physical addresses are 19-bits of the device physical address (e.g., the addresses used to address memory devices 120). Other, intermediate between the second level and the last page table level follow a similar pattern. The page table entries in the last page table level (“last page table level”) include a pointer to the full device physical address of the page and a content indicator.

FIG. 4B illustrate a full page table walks and reduced latency page table walks. In FIG. 4B, arrows 401-403 illustrate a first full page table walk to an uncompressed page. The first page table walk is illustrated beginning in page table level #1 indexing to the entry holding “1^{st} MSB PHYS ADDR #2” which has a content flag indicating that the range of memory associated with “1^{st} MSB PHYS ADDR #2” includes at least one page of compressed memory. As illustrated by arrow 401, the page table entry “1^{st} MSB PHYS ADDR #2” indexes to the “2^{nd} MSB PHYS ADDR #1” entry in page table level #2. The “2^{nd} MSB PHYS ADDR #1” entry in page table level #2 has a content flag indicating that the range of memory associated with “2^{nd} MSB PHYS ADDR #1” includes at least one page of compressed memory. This continues for additional page table levels, if any. However, for the sake of brevity, this discussion will skip those levels (if any).

As illustrated by arrow 402, the page table entry “2^{nd} MSB PHYS ADDR #1” indexes to the “FULL PHYS ADDR #R” entry in the last page table level. The “FULL PHYS ADDR #R” entry in last page table level has a content flag indicating that the page of memory associated with “FULL PHYS ADDR #R” does not include compressed memory. Thus, as illustrated by arrow 403, “FULL PHYS ADDR #R” indexes to uncompressed page 435. A similar walk to the last page table level may lead to the “FULL PHYS ADDR #S” entry in the last page table level. The “FULL PHYS ADDR #S” entry in last page table level has a content flag indicating that the page of memory associated with “FULL PHYS ADDR #S” includes compressed memory. Thus, as illustrated by arrow 404, “FULL PHYS ADDR #S” indexed to compressed page 432. It should be understood that the page table walks illustrated by arrows 401-404 are full page table walks and thus, on average, incur the longest latencies.

In FIG. 4B, arrows 405-406 illustrate a first lower latency page table walk to an uncompressed page. The first lower latency page table walk is illustrated beginning in page table level #1 indexing to the entry holding “1st MSB PHYS ADDR #N” which has a content flag indicating that the range of memory associated with “1^{st} MSB PHYS ADDR #2” includes at least one page of compressed memory. As illustrated by arrow 405, the page table entry “1^{st} MSB PHYS ADDR #N” indexes to the “2^{nd} MSB PHYS ADDR #P” entry in page table level #2. The “2^{nd} MSB PHYS ADDR #P” entry in page table level #2 has a content flag indicating that the range of memory associated with “2^{nd} MSB PHYS ADDR #1” does not include at least one page of compressed memory. Thus, based on this content flag indicating the range of memory associated with “2^{nd} MSB PHYS ADDR #1” does not include at least one page of compressed memory, further levels of page table walks do not need to be performed. The further levels of page table walks do not need to be performed because the pointer in the entry “2^{nd} MSB PHYS ADDR #1” may be combined with the least significant bits of the address being walked to produce the full device physical address. This is illustrated in FIG. 4B by arrow 406 running from the entry “2^{nd} MSB PHYS ADDR #1” in page table level #2 to uncompressed page 437.

In FIG. 4B, arrow 407 illustrates a second lower latency page table walk to an uncompressed page. The second lower latency page table walk is illustrated beginning in page table level #1 indexing to the entry holding “1^{st} MSB PHYS ADDR #M” which has a content flag indicating that the range of memory associated with “1^{st} MSB PHYS ADDR #M” does not include at least one page of compressed memory. Thus, based on this content flag indicating the range of memory associated with “1^{st} MSB PHYS ADDR #M” does not include at least one page of compressed memory, further levels of page table walks do not need to be performed. The further levels of page table walks do not need to be performed because the pointer in the entry “1^{st} MSB PHYS ADDR #M” may be combined with the least significant bits of the address being walked to produce the full device physical address. This is illustrated in FIG. 4B by arrow 407 running from the entry “1^{st} MSB PHYS ADDR #M” in page table level #1 to uncompressed page 437.

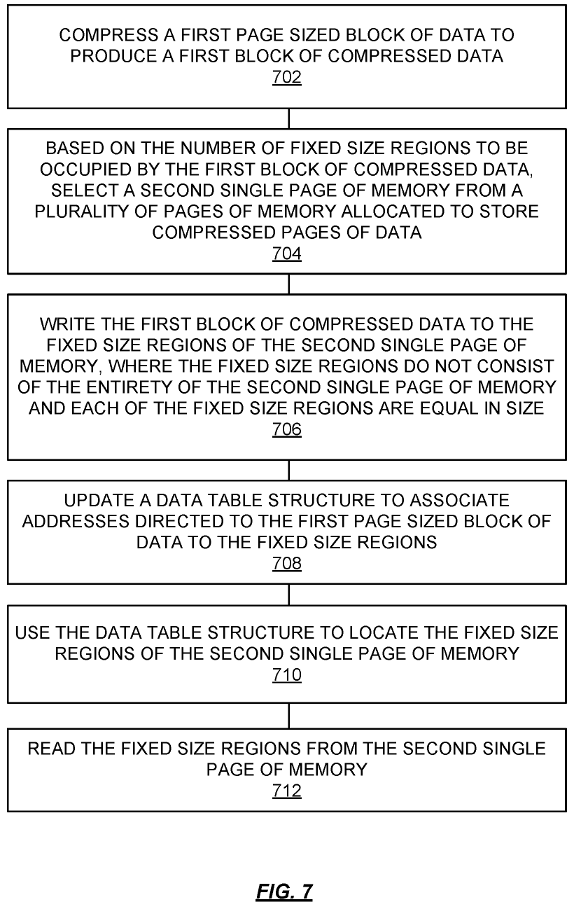

FIG. 5 is a flowchart illustrating a method of compressing memory. One or more steps illustrated in FIG. 5 may be performed by, for example, system 100, system 200, and/or their components. By a memory buffer device, a first page sized block of data read from a first single page of memory is compressed to produce a first block of compressed data from the first page sized block of data (502). For example, buffer device 111 (and access circuitry 113, in particular) may read an uncompressed page 131 from memory devices 120, provide the uncompressed page 131 to compression circuitry 112, to produce a compressed block of data. In another example, access circuitry 213 of buffer device 211 may read uncompressed page 221 and provide the uncompressed contents, “A”, of uncompressed page 221 to compression circuitry 212. Compression circuitry 212 may compress the contents “A” of uncompressed page 221 to compressed data “a” that will need to occupy three slots.

The first block of compressed data is written to one or more fixed sized regions of a second single page of memory where the one or more fixed size regions do not consist of the entirety of the second single page of memory and each of the fixed size regions are uniform is size (504). For example, buffer device 111 (and access circuitry 113, in particular) may write the compressed block of data to one, two, or three fixed sized slots of a page. In another example, access circuitry 213 may write compressed data “a” to three slots 222a-222c of compressed page 222. Slot 222d of compressed page 222 may be available to hold other compressed data.

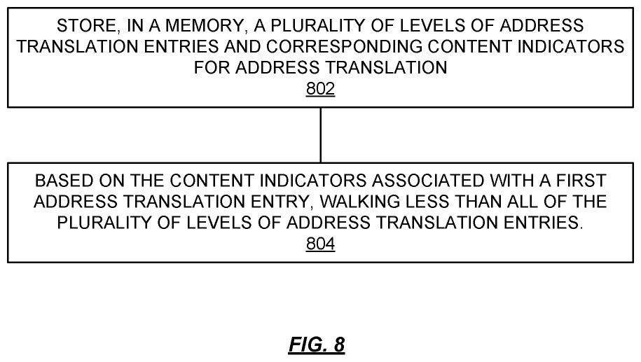

FIG. 6 is a flowchart illustrating a method of compressing and decompressing memory. One or more steps illustrated in FIG. 6 may be performed by, for example, system 100, system 200, and/or their components. A first page sized block of data read from a first single page of memory is compressed to produce a first block of compressed data (602). For example, access circuitry 213 may read uncompressed page 221 and provide the uncompressed contents, “A”, of uncompressed page 221 to compression circuitry 212. Compression circuitry 212 may compress the contents “A” of uncompressed page 221 to compressed data “a” that will need to occupy three slots.

Based on the number of fixed size regions to be occupied by the first block of compressed data, a second single page of memory is selected from a plurality of pages of memory allocated to store compressed pages of data (604). For example, based on compressed data “a” needing to occupy three slots, and compressed page 228 having three available slots, buffer device 211 may select a compressed page 228 from a 3-slot queue 323. The first block of compressed data is written to one or more fixed size regions of the second single page of memory, where the one or more fixed size regions do not consist of the entirety of the second single page of memory and each of the fixed size regions are uniform in size (606). For example, access circuitry 213 may write compressed data “a” to three slots 228b-228d of compressed page 228.

In response to an access to an address associated with the first single page of memory, the one or more fixed size regions of the second single page of memory is read to produce a second block of compressed data (608). For example, in response to an access request an address associated with compressed data “a”, access circuitry 213 may read slots 228b-228d of compressed page 228 and provide the compressed contents, “a”, of slots 228b-228d to compression circuitry 212. The second block of compressed data is decompressed to produce a second page sized block of data (610). For example, compression circuitry 212 may decompress the contents “a” of slots 228b-228d to uncompressed page data “A” that will need to occupy an entire page. The second page sized block of data is written to a third single page of memory (612). For example, uncompressed page data “A” may be provided to access circuitry 213. Access circuitry 213 may write uncompressed page data “A” to uncompressed page 229.

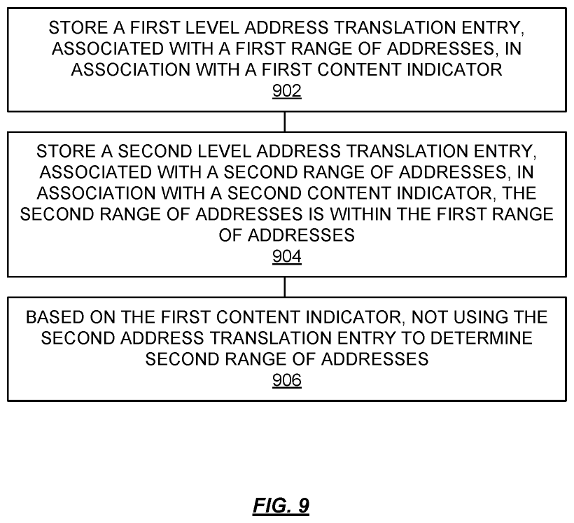

FIG. 7 is a flowchart illustrating a method of maintaining a page table. One or more steps illustrated in FIG. 7 may be performed by, for example, system 100, system 200, and/or their components. A first page sized block of data is compressed to produce a first block of compressed data (702). For example, buffer device 111 (and compression circuitry 112, in particular) may compress an uncompressed page 131 to produce a compressed block of data that will occupy a first number (e.g., 1, 2, or 3) of slots. In another example, access circuitry 213 of buffer device 211 may read uncompressed page 223 and provides the uncompressed contents, “B”, of uncompressed page 223 to compression circuitry 212. Compression circuitry 212 may compress the contents “B” of uncompressed page 223 to compressed data “b” that will need to occupy two slots.

Based on the number of fixed size regions to be occupied by the first block of compressed data, a second single page of memory is selected from a plurality of pages of memory allocated to store compressed pages of data (704). For example, based on compressed data “b” needing to occupy two slots, and compressed page 224 having at least two available slots, buffer device 111 may select compressed page 224 from a 2-slot queue 322. The first block of compressed data is written to the fixed size regions of the second single page of memory, where the fixed size regions do not consist of the entirety of the second single page of memory and each of the fixed size regions are equal in size (706). For example, access circuitry 213 may write compressed data “b” to two slots 224ab-224b of compressed page 224.

A data table structure is updated to associate addresses directed to the first page sized block of data to the fixed size regions (708). For example, page table control circuitry 115 may update one or more page table entries 136a-137a in page table 135 to associate the two slots 224a-224b holding compressed data “b” with the system node 150 address range previously associated with uncompressed page 223. The data table structure is used to locate the fixed sized regions of the second single page of memory (710). For example, based on an access by system node 150 to address range previously associated with uncompressed page 223, page table walker circuitry 116 may use page table 135 to locate slots 224a-224b of compressed page 224. The fixed size regions are read from the second single page of memory (712). For example, access circuitry 213 may read 224a-224b of compressed page 224 and provide the contents of slots 224a-224b to compression circuitry 212.

FIG. 8 is a flowchart illustrating a method of walking a page table. One or more steps illustrated in FIG. 8 may be performed by, for example, system 100, system 200, and/or their components. A plurality of levels of address translation entries and corresponding content indicators are stored, in a memory, for address translation (802). For example, page table control circuitry 115 may store, in page table 135, a plurality of levels of page table entries 136a-137a for address translation of system node 150 addresses to memory node addresses used to address memory devices 120, where the plurality of levels of page table entries 136a-137a each include content indicators 136b-137b.

Based on the content indicators associated with a first address translation entry, less than all of the plurality of levels of address translation are walked (804). For example, based on content indicator 136b indicating that the address range associated with page table entry 136a does not include a compressed page, page table walker circuitry 116 may walk less than all of the levels of page table 135.

FIG. 9 is a flowchart illustrating a method of decreasing page table walk latency. One or more steps illustrated in FIG. 9 may be performed by, for example, system 100, system 200, and/or their components. A first level address translation entry associated with a first range of address is stored in association with a first content indicator (902). For example, page table control circuitry 115 may store a first level page table entry 136a in association with content indicator 136b, where page table entry 136a is associated with a first range of system node 150 addresses.

A second level address translation entry associated with a second range of address is stored in association with a second content indicator, where the second range of addresses is within the first range of addresses (904). For example, page table control circuitry 115 may store a second level page table entry 137a in association with content indicator 137b, where page table entry 137a is associated with a second range of system node 150 addresses that is within the range of system node 150 addresses associated with page table entry 136a. Based on the first content indicator, the second address translation entry is not used to determine the second range of addresses (906). For example, based on the first content indicator indicating that the first range of system node 150 address does not contain a compressed page, page table walker circuitry 116 may resolve the full address for memory devices 120 without using the address translation stored by page table entry 137a.

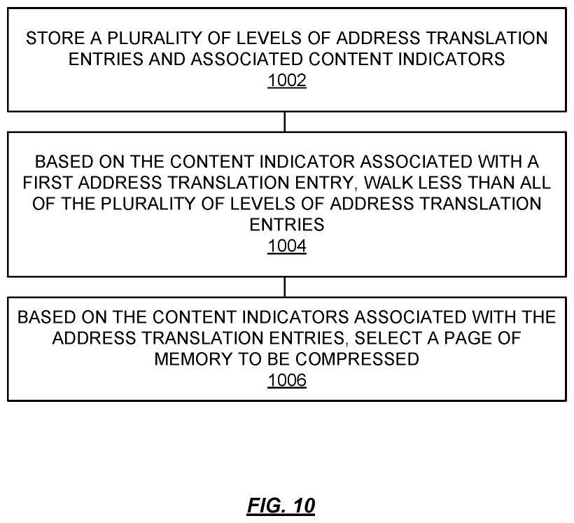

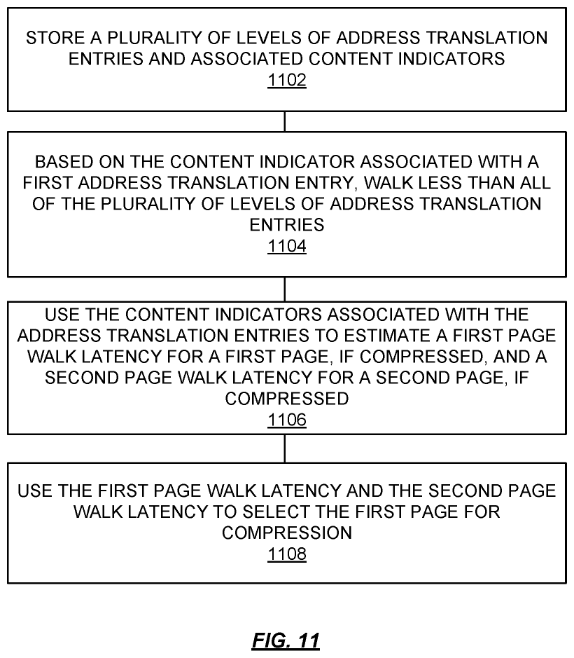

FIG. 10 is a flowchart illustrating a method of selecting a page of memory for compression. One or more steps illustrated in FIG. 10 may be performed by, for example, system 100, system 200, and/or their components. A plurality of levels of address translation entries and associated content indicators are stored (1002). For example, page table control circuitry 115 may store, in page table 135, a plurality of levels of page table entries 136a-137a for address translation of system node 150 addresses to memory node addresses used to address memory devices 120, where the plurality of levels of page table entries 136a-137a each include content indicators 136b-137b.

Based on the content indicator associated with a first address translation entry, less than all of the plurality of levels of address translation entries are walked (1004). For example, based on content indicator 136b indicating that the address range associated with page table entry 136a does not include a compressed page, page table walker circuitry 116 may walk less than all of the levels of page table 135. Based on the content indicators associated with the address translation entries, a page of memory is selected to be compressed (1006). For example, if the block of memory associated with page table entry 136a is indicated by content indicator 136b to include a compressed page, while the block of memory associated with page table entry 137a is indicated by content indicator 137b to not include a compressed page, control circuitry 114 may select a page from the block of memory associated with page table entry 136a to compress. This selection will not increase the time needed to fully walk the page table. Whereas, selecting a page from the block of memory associated with page table entry 137a will, after that page is compressed, require a full page table walk that was not required before the page from the block of memory associated with page table entry 137a was compressed.

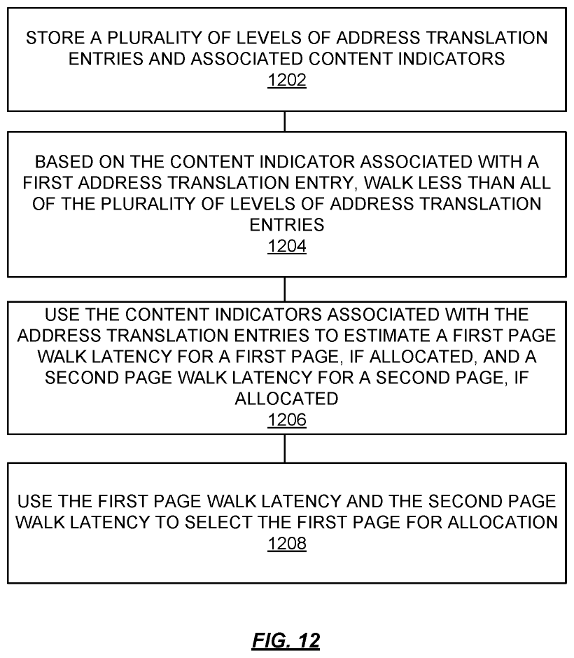

FIG. 11 is a flowchart illustrating a latency based method of selecting a page of memory for compression. One or more steps illustrated in FIG. 11 may be performed by, for example, system 100, system 200, and/or their components. A plurality of levels of address translation entries and associated content indicators are stored (1102). For example, page table control circuitry 115 may store, in page table 135, a plurality of levels of page table entries 136a-137a for address translation of system node 150 addresses to memory node addresses used to address memory devices 120, where the plurality of levels of page table entries 136a-137a each include content indicators 136b-137b.

Based on the content indicator associated with a first address translation entry, less than all of the plurality of levels of address translation entries are walked (1104). For example, based on content indicator 136b indicating that the address range associated with page table entry 136a does not include a compressed page, page table walker circuitry 116 may walk less than all of the levels of page table 135. The content indicator associated with the address translation entries are used to estimate a first page walk latency for a first page, if compressed, and a second page walk latency for a second page, if compressed (1106). For example, if the block of memory associated with page table entry 136a is indicated by content indicator 136b to include a compressed page, control circuitry 114 may estimate that the page walk latency for pages in the range of pages associated with page table entry 136a will be that of a full page table walk. Similarly, if the block of memory associated with page table entry 137a is indicated by content indicator 137b to not include a compressed page, control circuitry 114 may estimate that the page walk latency for selecting a page in the range of pages associated with page table entry 137a will increase from less than of a full page table walk to a full page table walk.

The first page walk latency and the second page walk latency are used to select the first page for compression (1108). For example, control circuitry 114 may use the information that the page walk latency associated with selecting a page from the range of pages associated with page table entry 136a will be that of a full page table walk and that the page walk latency selecting a pages from the range of pages associated with page table entry 137a will increase the latency for that range from less than a full page table walk to a full page table walk to select a page from the range of pages associated with page table entry 136a.

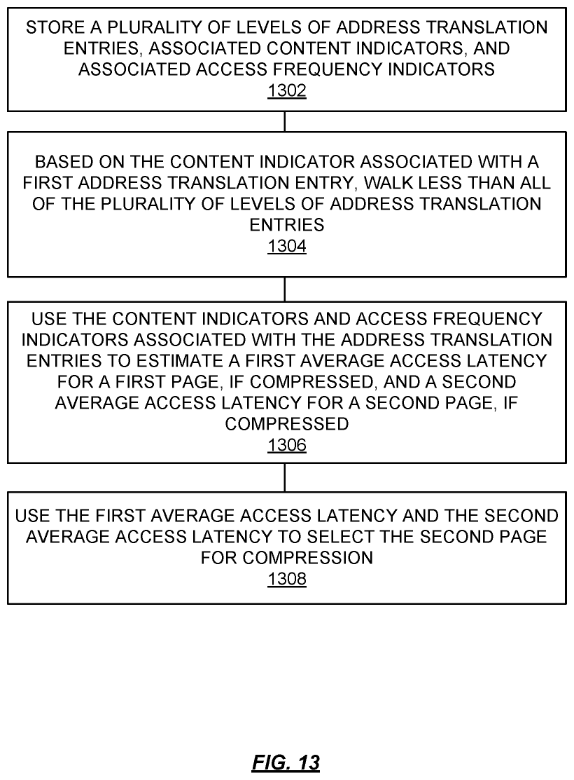

FIG. 12 is a flowchart illustrating a latency based method of selecting a page of memory for allocation. One or more steps illustrated in FIG. 12 may be performed by, for example, system 100, system 200, and/or their components. A plurality of levels of address translation entries and associated content indicators are stored (1202). For example, page table control circuitry 115 may store, in page table 135, a plurality of levels of page table entries 136a-137a for address translation of system node 150 addresses to memory node addresses used to address memory devices 120, where the plurality of levels of page table entries 136a-137a each include content indicators 136b-137b.

Based on the content indicator associated with a first address translation entry, less than all of the plurality of levels of address translation entries are walked (1204). For example, based on content indicator 136b indicating that the address range associated with page table entry 136a does not include a compressed page, page table walker circuitry 116 may walk less than all of the levels of page table 135. The content indicator associated with the address translation entries are used to estimate a first page walk latency for a first page, if allocated, and a second page walk latency for a second page, if allocated (1206). For example, if the block of memory associated with page table entry 136a is indicated by content indicator 136b to include a compressed page, control circuitry 114 may estimate that the page walk latency for pages in the range of pages associated with page table entry 136a will be that of a full page table walk. Similarly, if the block of memory associated with page table entry 137a is indicated by content indicator 137b to not include a compressed page, control circuitry 114 may estimate that the page walk latency for pages selected from the range of pages associated with page table entry 137a will be less than of a full page table walk.

The first page walk latency and the second page walk latency are used to select the first page for compression (1208). For example, control circuitry 114 may use the information that the page walk latency associated with selecting a page from the range of pages associated with page table entry 136a will be that of a full page table walk and that the page walk latency selecting a pages from the range of pages associated with page table entry 137a be less than a full page table walk to a full page table walk to select a page from the range of pages associated with page table entry 137a.

FIG. 13 is a flowchart illustrating a latency and access frequency based method of selecting a page of memory for compression. One or more steps illustrated in FIG. 13 may be performed by, for example, system 100, system 200, and/or their components. A plurality of levels of address translation entries, associated content indicators, and associated access frequency indicators are stored (1302). For example, page table control circuitry 115 may store, in page table 135, a plurality of levels of page table entries 136a-137a for address translation of system node 150 addresses to memory node addresses used to address memory devices 120, where the plurality of levels of page table entries 136a-137a each include content indicators 136b-137b and access frequency indicators 136c-137c.

Based on the content indicator associated with a first address translation entry, less than all of the plurality of levels of address translation entries are walked (1304). For example, based on content indicator 136b indicating that the address range associated with page table entry 136a does not include a compressed page, page table walker circuitry 116 may walk less than all of the levels of page table 135. The content indicators and access frequency indicators associated with the address translation entries are used to estimate a first average access latency for a first page, if compressed, and a second average access latency for a second page, if compressed (1306). For example, if a first block of memory associated with a first page table entry (e.g., page table entry 136a) is indicated (e.g., by content indicator 136b) to include a compressed page, while a second block of memory associated with a second page table entry (e.g., page table entry 137a) is indicated (e.g., by content indicator 137b) to not include a compressed page, but the access frequency indicators associated with the first page and the second page indicate the first page is infrequently accessed when compared to the second page, selecting a page from the second block of memory to compress may not increase the average access time even when having to fully walk the page table. Whereas, selecting a page from the first block of memory will, after that page is compressed, require a full page table walk but will only occur infrequently thereby not increasing the average access time.

In another example, if a first block of memory associated with a first page table entry (e.g., page table entry 136a) is indicated (e.g., by content indicator 136b) to include a compressed page, while a second block of memory associated with a second page table entry (e.g., page table entry 137a) is indicated (e.g., by content indicator 137b) to not include a compressed page, and the access frequency indicators associated with the first page and the second page indicate the first page and the second page are accessed with equal (or approximately equal—e.g., within 10%), selecting a page from the first block of memory to compress will not increase the average access time because accesses to the first block of memory already require a full page table walk. Whereas, selecting a page from the second block of memory will, after that page is compressed, subsequently require a full page table walk that would not have been incurred prior to compressing the second block of memory—thereby increasing average access latency.

The first average access latency and the second average access latency are used to select the second page for compression (1308). For example, control circuitry 114 may use the information that the page walk latency associated with selecting a page from the range of pages associated with page table entry 136a will be that of a full page table walk, but that full page table walk will occur infrequency thereby not significantly increasing the average access latency. In another example, control circuitry 114 may use the information that the page walk latency associated with selecting a page from the range of pages associated with page table entry 136b will be increased to that of a full page table walk if a page from the range of pages associated with page table entry 136b is selected for compression.

In another embodiment, decisions to move (or migrate) pages to other page ranges may be based on the access frequency indicators. For example, based on access frequency indicator 136c-137c, control circuitry 114 may determine that one or a few pages are causing longer page table walks for a range of pages. Control circuitry 114 may then autonomously migrate the page(s) and inform system node 150 of the new address and/or inform system node 150t that a migration should take place

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of system 100, system 200, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

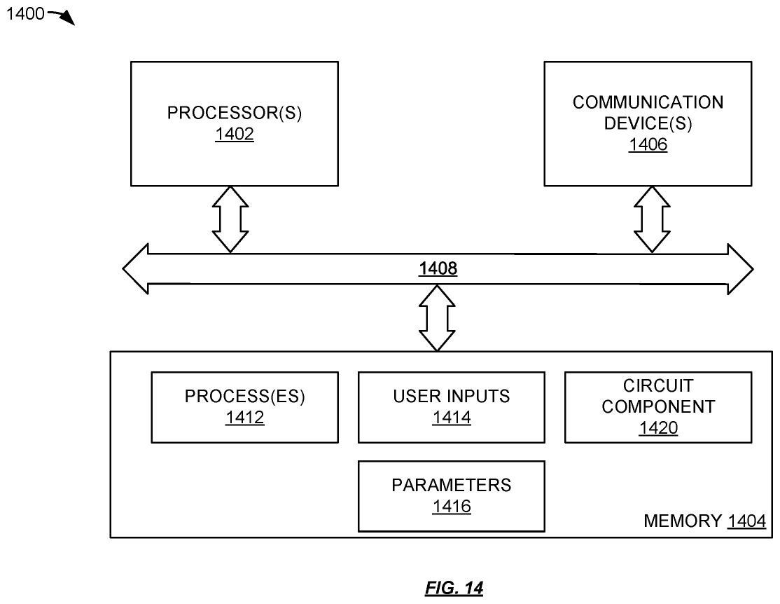

FIG. 14 is a block diagram illustrating one embodiment of a processing system 1400 for including, processing, or generating, a representation of a circuit component 1420. Processing system 1400 includes one or more processors 1402, a memory 1404, and one or more communications devices 1406. Processors 1402, memory 1404, and communications devices 1406 communicate using any suitable type, number, and/or configuration of wired and/or wireless connections 1408.

Processors 1402 execute instructions of one or more processes 1412 stored in a memory 1404 to process and/or generate circuit component 1420 responsive to user inputs 1414 and parameters 1416. Processes 1412 may be any suitable electronic design automation (EDA) tool or portion thereof used to design, simulate, analyze, and/or verify electronic circuitry and/or generate photomasks for electronic circuitry. Representation 1420 includes data that describes all or portions of system 100, system 200, and their components, as shown in the Figures.

Representation 1420 may include one or more of behavioral, register transfer, logic component, transistor, and layout geometry-level descriptions. Moreover, representation 1420 may be stored on storage media or communicated by carrier waves.

Data formats in which representation 1420 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email

User inputs 1414 may comprise input parameters from a keyboard, mouse, voice recognition interface, microphone and speakers, graphical display, touch screen, or other type of user interface device. This user interface may be distributed among multiple interface devices. Parameters 1416 may include specifications and/or characteristics that are input to help define representation 1420. For example, parameters 1416 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1404 includes any suitable type, number, and/or configuration of non-transitory computer-readable storage media that stores processes 1412, user inputs 1414, parameters 1416, and circuit component 1420.

Communications devices 1406 include any suitable type, number, and/or configuration of wired and/or wireless devices that transmit information from processing system 1400 to another processing or storage system (not shown) and/or receive information from another processing or storage system (not shown). For example, communications devices 1406 may transmit circuit component 1420 to another system. Communications devices 1406 may receive processes 1412, user inputs 1414, parameters 1416, and/or circuit component 1420 and cause processes 1412, user inputs 1414, parameters 1416, and/or circuit component 1420 to be stored in memory 1404.

Implementations discussed herein include, but are not limited to, the following examples:

Example 1. A device, comprising: data compression circuitry to compress a first page sized block of data read from a first single page of memory and produce a first block of compressed data from the first page sized block of data; and circuitry to write the first block of compressed data to one or more fixed size regions of a second single page of memory, where the one or more fixed size regions do not consist of an entirety of the second single page of memory and each of the fixed size regions are uniform in size.

Example 2: The device of example 1, further comprising: selection circuitry to, based on a number of fixed size regions to be occupied by the first block of compressed data, select the second single page of memory from a plurality of pages of memory allocated to store compressed pages of data.

Example 3: The device of example 2, further comprising: compressed memory access circuitry to, at least in response to an access to an address associated with the first single page of memory, read the one or more fixed size regions of the second single page of memory to produce a second block of compressed data.

Example 4: The device of example 3, further comprising: decompression circuitry to decompress the second block of compressed data and produce a second page sized block of data; and circuitry to write the second page sized block of data to a third single page of memory.

Example 5: The device of example 4, further comprising: circuitry to maintain a data table structure to associate addresses associated with the first page sized block of data to the one or more fixed size regions.

Example 6: The device of example 5, wherein the first single page of memory may be reallocated for use by a host device.

Example 7: The device of example 5, wherein the first single page of memory, the second single page of memory, and third single page of memory reside in dynamic random access memory (DRAM).

Example 8: A device, comprising: data compression circuitry to compress page sized blocks of data read from single pages of memory and produce blocks of compressed data from the page sized blocks of data; and circuitry to write the blocks of compressed data, respectively, to one or more fixed size regions of other single pages of memory, where the one or more fixed size regions do not consist of an entirety of the other single pages of memory and each of the fixed size regions are uniform in size.

Example 9: The device of example 8, further comprising: selection circuitry to, based on a number of fixed size regions to be occupied by a respective block of compressed data, respectively select the other single pages of memory from a plurality of pages of memory allocated to store compressed pages of data.

Example 10: The device of example 9, further comprising: compressed memory access circuitry to, in response to accesses to addresses associated with the single pages of memory, respectively read and decompress the one or more fixed size regions of the other single pages of memory.

Example 11: The device of example 10, further comprising: circuitry to write decompressed versions of the one or more fixed size regions of the other single pages of memory to single pages of memory.

Example 12: The device of example 11, further comprising: circuitry to maintain a data table structure that associates addresses directed to the page sized blocks of data, respectively, to a corresponding set of the one or more fixed size regions.

Example 13: The device of example 12, wherein the single pages of memory, after being compressed, may be reallocated for use by a host device.

Example 14: The device of example 13, wherein single pages of memory and the other single pages of memory reside in dynamic random access memory (DRAM).

Example 15: A method, comprising: compressing, by a memory buffer device, a first page sized block of data read from a first single page of memory to produce a first block of compressed data from the first page sized block of data; and writing the first block of compressed data to one or more fixed size regions of a second single page of memory, where the one or more fixed size regions do not consist of an entirety of the second single page of memory and each of the fixed size regions are uniform in size.

Example 16: The method of example 15, further comprising: based on a number of fixed size regions to be occupied by the first block of compressed data, selecting the second single page of memory from a plurality of pages of memory allocated to store compressed pages of data.

Example 17: The method of example 16, further comprising: at least in response to an access to an address associated with the first single page of memory, reading the one or more fixed size regions of the second single page of memory to produce a second block of compressed data.

Example 18: The method of example 17, further comprising: decompressing the second block of compressed data to produce a second page sized block of data; and writing the second page sized block of data to a third single page of memory.

Example 19: The method of example 17, further comprising: maintaining a data table structure that associates addresses directed to the first page sized block of data to the one or more fixed size regions.

Example 20: The method of example 19, further comprising: allocating the first single page of memory for use by a host device.

Example 21: A device, comprising: memory to store a plurality of levels of address translation entries and corresponding content indicators for address translation entries; and circuitry to, based on the content indicators associated with a first address translation entry, walk less than all of the plurality of levels of address translation entries.

Example 22: The device of example 21, wherein the content indicators are associated with whether a block of memory associated with the address translation entry includes at least one compressed page of memory.

Example 23: The device of example 22, wherein the first address translation entry is not a last level translation entry.

Example 24: The device of example 23, further comprising: page selection circuitry to select, based on the content indicators, a page of memory to be compressed.

Example 25: The device of example 24, wherein the page selection circuitry selects the page of memory to be compressed based on a first page walk latency for a first page, if compressed, and a second page walk latency for a second page, if compressed.

Example 26: The device of example 25, further comprising: page allocation circuitry to, based on the content indicators, select pages of memory to be allocated for use by a host based on a first page walk latency for a first page, if allocated, and a second page walk latency for a second page, if allocated.

Example 27: The device of example 25, further comprising: page allocation circuitry to, based on the content indicators, select pages of memory to be relocated based on a first page walk latency for a first page, if relocated, and a second page walk latency for the first page, if not relocated.

Example 28: A device, comprising: first memory to store a plurality of levels of page table entries, the page table entries including content indicators associated with a range of memory corresponding to a respective page table entry; second memory to store the range of memory corresponding to each respective page table entry; and page table walking circuitry to, based on the content indicators walk less than all of the plurality of levels of page table entries.

Example 29: The device of example 28, wherein the content indicators are associated with whether the range of memory corresponding to a respective page table entry includes at least one compressed page of memory.

Example 30: The device of example 29, wherein a first content indicator is associated with a block of memory that comprises more than a single page.

Example 31: The device of example 30, further comprising: page selection circuitry to select, based on the content indicators, a page of memory to be compressed.

Example 32: The device of example 31, wherein the page selection circuitry selects the page of memory to be compressed based on a first page walk latency for a first page, if compressed, and a second page walk latency for a second page, if compressed.

Example 33: The device of example 31, further comprising: page allocation circuitry to, based on the content indicators, select pages of memory to be allocated for use by a host based on a first page walk latency for a first page, if allocated, and a second page walk latency for a second page, if allocated.

Example 34: The device of example 31, further comprising: page allocation circuitry to, based on the content indicators, select pages of memory to be relocated based on a first page walk latency for a first page, if relocated, and a second page walk latency for the first page, if not relocated.

Example 35: A method, comprising: storing a plurality of levels of address translation entries and corresponding content indicators for address translation entries in a memory; and based on the content indicators associated with a first address translation entry, walking less than all of the plurality of levels of address translation entries.

Example 36: The method of example 35, wherein the content indicators are associated with whether a block of memory associated with the address translation entry includes at least one compressed page of memory.

Example 37: The method of example 36, wherein the first address translation entry is not a last level translation entry.

Example 38: The method of example 37, further comprising: selecting, based on the content indicators, a page of memory to be compressed.

Example 39: The method of example 38, wherein selecting the page of memory to be compressed is based on a first page walk latency for a first page, if compressed, and a second page walk latency for a second page, if compressed.

Example 40: The method of example 38, further comprising: based on the content indicators, selecting pages of memory to be allocated for use by a host based on a first page walk latency for a first page, if allocated, and a second page walk latency for a second page, if allocated.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A device, comprising:
data compression circuitry to compress a first page sized block of data read from a first single page of memory and produce a first block of compressed data from the first page sized block of data; and
circuitry to write the first block of compressed data to one or more fixed size regions of a second single page of memory, where the one or more fixed size regions do not consist of an entirety of the second single page of memory and each of the fixed size regions are uniform in size.

2. The device of claim 1, further comprising:
selection circuitry to, based on a number of fixed size regions to be occupied by the first block of compressed data, select the second single page of memory from a plurality of pages of memory allocated to store compressed pages of data.

3. The device of claim 2, further comprising:
compressed memory access circuitry to, at least in response to an access to an address associated with the first single page of memory, read the one or more fixed size regions of the second single page of memory to produce a second block of compressed data.

4. The device of claim 3, further comprising:
decompression circuitry to decompress the second block of compressed data and produce a second page sized block of data; and
circuitry to write the second page sized block of data to a third single page of memory.

5. The device of claim 4, further comprising:
circuitry to maintain a data table structure to associate addresses associated with the first page sized block of data to the one or more fixed size regions.

6. The device of claim 5, wherein the first single page of memory may be reallocated for use by a host device.

7. The device of claim 5, wherein the first single page of memory, the second single page of memory, and third single page of memory reside in dynamic random access memory (DRAM).

8. A device, comprising:
data compression circuitry to compress page sized blocks of data read from single pages of memory and produce blocks of compressed data from the page sized blocks of data; and
circuitry to write the blocks of compressed data, respectively, to one or more fixed size regions of other single pages of memory, where the one or more fixed size regions do not consist of an entirety of the other single pages of memory and each of the fixed size regions are uniform in size.

9. The device of claim 8, further comprising:
selection circuitry to, based on a number of fixed size regions to be occupied by a respective block of compressed data, respectively select the other single pages of memory from a plurality of pages of memory allocated to store compressed pages of data.

10. The device of claim 9, further comprising:
compressed memory access circuitry to, in response to accesses to addresses associated with the single pages of memory, respectively read and decompress the one or more fixed size regions of the other single pages of memory.

11. The device of claim 10, further comprising:
circuitry to write decompressed versions of the one or more fixed size regions of the other single pages of memory to single pages of memory.

12. The device of claim 11, further comprising:
circuitry to maintain a data table structure that associates addresses directed to the page sized blocks of data, respectively, to a corresponding set of the one or more fixed size regions.

13. The device of claim 12, wherein the single pages of memory, after being compressed, may be reallocated for use by a host device.

14. The device of claim 13, wherein single pages of memory and the other single pages of memory reside in dynamic random access memory (DRAM).

15. A method, comprising:
compressing, by a memory buffer device, a first page sized block of data read from a first single page of memory to produce a first block of compressed data from the first page sized block of data; and
writing the first block of compressed data to one or more fixed size regions of a second single page of memory, where the one or more fixed size regions do not consist of an entirety of the second single page of memory and each of the fixed size regions are uniform in size.

16. The method of claim 15, further comprising:
based on a number of fixed size regions to be occupied by the first block of compressed data, selecting the second single page of memory from a plurality of pages of memory allocated to store compressed pages of data.

17. The method of claim 16, further comprising:
at least in response to an access to an address associated with the first single page of memory, reading the one or more fixed size regions of the second single page of memory to produce a second block of compressed data.

18. The method of claim 17, further comprising:
decompressing the second block of compressed data to produce a second page sized block of data; and
writing the second page sized block of data to a third single page of memory.

19. The method of claim 17, further comprising:
maintaining a data table structure that associates addresses directed to the first page sized block of data to the one or more fixed size regions.

20. The method of claim 19, further comprising:
allocating the first single page of memory for use by a host device.
